(19) United States
(12) Patent Application Publication
(10) Pub. No.: US 2011/0304218 A1
(43) Pub. Date: Dec. 15, 2011

(54) Signal coupling system

(76) Inventors: Brendan Peter Hyland, Edinburgh (GB); Mark Volanthen, Hampshire (GB); Andrew Jaffrey, Inverurie (GB); Mark Rhodes, West Lothian (GB)

(21) Appl. No.: 13/159,637

(22) Filed: Jun. 14, 2011

(30) Foreign Application Priority Data
Jun. 15, 2010 (GB) 1010095.6

(51) Int. Cl. H02J 17/00

(52) U.S. Cl. 307/104

(57) ABSTRACT

A signal coupling system for data and/or power signalling in a confined space such as in tubing within a hydrocarbon extraction well. First and second transceivers are arranged with primary and secondary loops lying orthogonal to the ends of the transceivers. The transceivers can be narrower for access to confined spaces. Each loop is housed in a semi-cylindrical housing with a planar face, so providing a cylindrical body when oppositely arranged for the transfer of electromagnetic radiation therebetween. Guiding surfaces are also provided on the housing to assist in bring the coupling system together in the confined space.

### CROSS-REFERENCE TO RELATED APPLICATIONS

This application claims the benefit of GB1010095.6 filed Jun. 16, 2010, which application is fully incorporated herein by reference.

### FIELD OF THE INVENTION

The present invention relates to a signal coupling system for the transfer of data signals and/or power signals in a confined space. More particularly, the present invention relates to a signal coupling system having a primary loop and a secondary loop in a vertical orientation to provide electromagnetic coupling in confined spaces.

### BACKGROUND OF THE INVENTION

The extraction of hydrocarbons from a well system is a very challenging task with such systems typically comprising a complex network of metallic pipes through which oil or gas is supplied from an underground reservoir to a production platform. In the most complex installations the reservoir may be located within the ground beneath the sea where a production pipe system is utilized to carry extracted hydrocarbon from the seabed through a riser to a production platform located at the surface of the sea.

Typically, production operations require a great quantity of command and control information relating to parameters and conditions ‘downhole’. Such information typically includes characteristics such as pressure, temperature, flow rate, flow composition, flow direction and so on, along with data relating to the size and configuration of the wellbore itself. The requirement to provide such information is extremely challenging due to the very constrained nature of the pipe or tubing structure. The pipe structure is the most accessible route for any data signaling mechanism. Generally, such command and control of production activities are performed from a surface based control station on a surface production platform. Additionally, valves and drilling mechanisms are remotely controlled from the surface based control stations which rely on analysis of sensor data often from critical locations within the wellbore pipe structure. Remote data gathering sensors and control devices also require electrical power and this must also be supplied from the surface based control stations.

Remote signaling from downhole locations in an oil or gas well is well known in the art. For example ‘mud pulsing’ is a widely used telemetry system generating characteristic data whilst drilling, and which is commonly referred to as ‘measurement whilst drilling’. In general, the mud pulse system uses variations in pressure in the mud to transfer data to a control station. Acoustic signaling within the pipe walls and through the fluid carried by production pipes suffers from similar limitations. However, these systems do suffer from interference from the acoustic noise generated by drilling operations. Alternative techniques have been proposed such as hard wired conductive cable systems which provide data and power to remote locations within the pipe structure. This technique has also been found to be unreliable in an extreme environment such as in a well system. Furthermore, the production tubing and casing are assembled in sections and this complicates deployment of a wired system.

The fluids which flow in the tubing present in a wellbore contain abrasive materials, are often chemically reactive, and at high temperature and pressure. In this environment electrically conductive cables and electrically conductive connectors provide very low reliability. Moreover, hard wired cables are permanently interfaced to control devices and sensors and should one part of the system fail then this often results in failure of the whole command and control network. Such single point failure is highly undesirable in a wellbore system as the remedial work prevents production and is costly.

In summary, the communication systems described above are disadvantageous in that they are complicated to use, unreliable due to the harsh environment in which they are exposed, expensive to install and even more expensive to repair.

There is a need for a flexible system for reliably providing data communications and/or electrical power to remote equipment within a wellbore.

### SUMMARY OF THE INVENTION

Thus, it is an object of the present invention to provide a signal coupling system for the transfer of signals, for example data and/or power signals, which is suitable for use in a confined space.

It is a further object of at least one embodiment of the present invention to provide a signal coupling system for use in a hydrocarbon extraction well that recognizes the constraints of the tubing arrangement and thus maximizes the communication area between first and second transceiver.

It is a yet further object of at least one embodiment of the present invention to provide a signal coupling system for the transfer of signals in a hostile environment such as in a wellbore.

It is a further object of at least one embodiment of the present invention to provide a signal coupling system in which a majority of the system can be removed and replaced easily within a wellbore.

According to a first aspect of the present invention there is provided a signal coupling system for the transfer of data and/or power signals, the system comprising:

a first transceiver having a primary loop arranged at a first end thereof with a first plane enclosed by said primary loop being arranged substantially orthogonal to said first end;

a second transceiver having a secondary loop arranged at a second end thereof with a second plane enclosed by said secondary loop being arranged substantially orthogonal to said second end;

said transceivers arranged oppositely with said first and said second ends overlapping such that said first plane and said second plane are in substantially parallel alignment to facilitate electromagnetic coupling therebetween.

In this way, the loops are arranged in a vertical orientation making the system slimmer than the conventional horizontal arrangement. The system can therefore be easily located in confined spaces such as tubing in a wellbore.

Preferably, said primary and said secondary loop are directly opposed to maximise the electromagnetic coupling.

In this way, optimum coupling surfaces are presented by the loops facing each other in horizontal alignment.

Preferably, said first and second ends are semi-cylindrical housings in which are located said primary and said secondary loops respectively, each housing having a first and second face respectively and said first and second faces being in substantially parallel alignment with said primary and said secondary loops respectively.

In this way, the loops are protected in housings which can withstand use in harsh environments.

Preferably, said first and second faces are arranged oppositely to provide a substantially cylindrical coupling member.

In this way, the coupling member has a circumferential diameter which can be selected to fit within known tubing diameters, leaving sufficient bypass area for fluids.

Preferably said first and second transceivers are substantially cylindrical members such that the system has a substantially cylindrical body.

In this way, the system can have a fixed diameter sized to match the cable thickness for deployment.

Preferably, a ledge formed at a junction of said cylindrical member and said semi-cylindrical housing provides a guide surface.

In this way, the semi-cylindrical sections can be brought together remotely with an indication being given that contact has been made.

Preferably, a front surface at a distal end of said cylindrical housing is shaped to mate with said guide surface.

In this way, a positive contact between the two transceivers can be made.

Preferably, said front surface and said guide surface are arranged at an angle with respect to said first face.

In this way, the two transceivers can be guided by rotational alignment.

According to a second aspect of the present invention there is provided a method of data and/or power transfer, comprising the steps:

(a) providing a signal coupling system according to the first aspect;

(b) connecting said first transceiver to a device;

(c) bringing said second transceiver to said first transceiver;

(d) overlapping said ends of said receivers to bring said primary loop and said secondary loop into alignment; and

(e) transmitting data and/or power between said transceivers by electromagnetic induction.

In this way, the second transceiver can be removed for repair and/or replacement, so making the system more reliable. Additionally, as the data and/or power can be transmitted when the transceivers are close to each other, a remote connection does not have to be made. The receipt of data at the surface will indicate that coupling has been achieved.

Preferably, the method includes the step of rotationally aligning mating surfaces on said transceivers.

In this way, the orientation of the transceivers can be made remotely.

### BRIEF DESCRIPTION OF DRAWINGS

A better understanding of the features and advantages of the present invention will be obtained by reference to the following detailed description that sets forth illustrative embodiments by way of example only, with reference to the accompanying drawings of which:

FIG. 1 shows a simplified view of a signal coupling system of present invention arranged within a production tubing of a hydrocarbon extraction well according to an embodiment of the present invention;

FIG. 2 shows a simplified view of a first transceiver for the transmission and receiving of signals (e.g. data and/or power) according to an embodiment of the present invention;

FIG. 3 shows a side view of the transceiver of FIG. 2;

FIG. 4a shows a schematic illustration of use of a signal coupling system in a pipe section according to an embodiment of the present invention;

FIG. 4b shows a simplified block diagram of the transceivers and associated circuitry for communicating between command center and a device arranged within a confined space according to an embodiment of the present invention;

FIG. 5 shows a simplified front view of a first transceiver according to an alternative embodiment of the present invention;

FIG. 6 shows a simplified plan view of a first transceiver according to an embodiment of the present invention;

FIG. 7 shows a simplified tubing section within a casing of a well production system;

FIG. 8 shows a simplified view of a signal coupling system according to an embodiment of the present invention located within tubing; and

FIG. 9 shows a simplified overview of an example hydrocarbon well production system incorporating a signal coupling system according to an embodiment of the present invention.

### DETAILED DESCRIPTION OF THE INVENTION

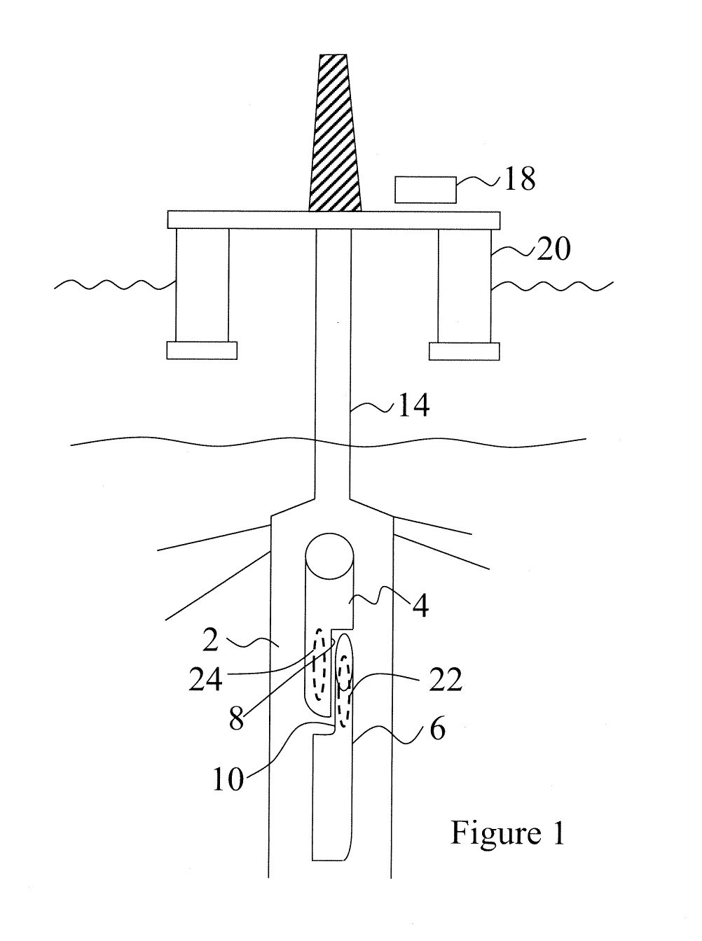

FIG. 1 shows a simplified view of a signal coupling system 2 of the present invention arranged within a production tubing of a hydrocarbon extraction facility. The signal coupling system 2 comprises a first transceiver 4 and second transceiver 6 and made generally of a first and second elongated cylindrical housing which extends semi-cylindrically to define a first and a second planar plate-like area 8, 10. The first elongated cylindrical housing 4 contains interface circuitry between a multi-turn primary coil 22 and control circuitry for bi-directional signalling to/from a surface based control station. Similarly, second elongated cylindrical housing 6 for the containment of interface circuitry between a multi-turn secondary coil 24 and control circuitry for bi-directional signalling to/from at least one sensor (e.g. for sensing characteristics pressure, temperature, flow rate, flow composition, flow direction and so on). Typically, elongated cylindrical element is made of a resilient material best suited to protect the accommodated circuitry from the deleterious effects of a production well environment. As will be described later in detail, first and second planar plate-like areas 8, 10 are aligned mostly congruent to create a signal coupling system and arranged (as will be described later) along the longitudinal axis of a production tubing.

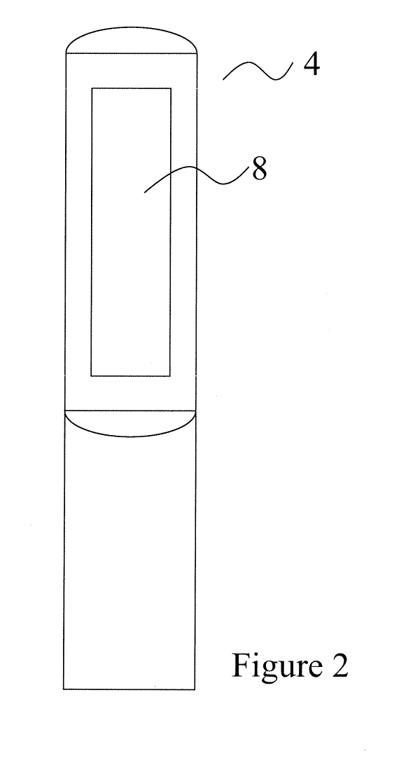

FIG. 2 shows a simplified view of a first transceiver which is adapted for the transmission of signals such as data and or power signals to a second transceiver (not shown) according to an embodiment of the present invention. The first transceiver housing shown in the drawing is made generally of an elongated cylindrical element and which extends semi-cylindrically to define a planar plate-like area. The elongated cylindrical housing 4 is for the containment of interface circuitry between a multi-turn primary coil 22 and control bi-directional signalling to/from a surface based control station. Housing encloses the primary coil 22 and provides a first flux guiding structure. Similarly, second transceiver housing encloses a secondary coil 24 and which further has a second flux guiding structure. Although not depicted in the current figure, each guiding structure is recessed for accommodating each coil and being so arranged parallel to planar plate-like area. Each plate-like area 8 increases the surface area of the coupling region between first and second transceiver 4, 6 thus reducing the magnetic reluctance of the gap at the interface between the transceivers.

Generally, multi-turn primary coil extends along elongated cylindrical housing part being accommodated parallel to plate-like area of housing. In particular, planar plate-like area provides a protective cover for primary coil to allow mechanically opposite second transceiver to overlap for the purpose of transferring of data and/or power signals therebetween as will described later.

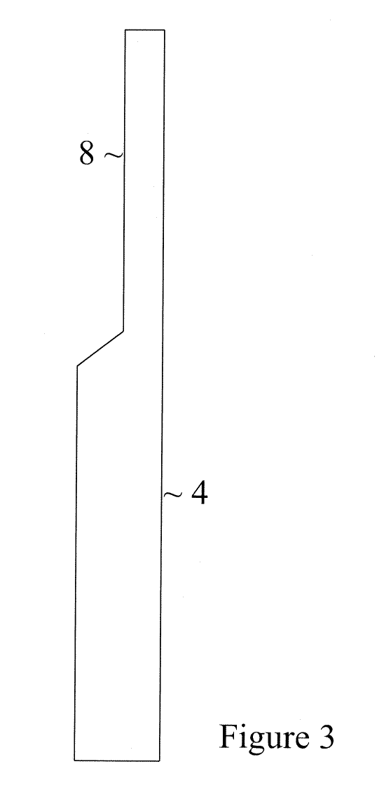

FIG. 3 shows a simplified and an exaggerated side view of a first transceiver 4 according to an embodiment of the present invention. For the purpose of clarity, and as depicted in the current figure, first transceiver element is rotated by 180 degrees as compared to the illustration of first transceiver of FIG. 2. Cylindrical housing is for the containment of interface circuitry which interfaces between a multi-turn primary coil (not shown) and control bi-directional signalling to/from a surface based control station. Typically, elongated cylindrical like element is made of a material best suited to protect the accommodated circuitry from deleterious effects of production well environment. The magnetic circuit formed by the flux guide enclosures provides space to accommodate the primary winding that provides the magneto motive force of the signal coupling system. The secondary flux guide also accommodates a secondary winding of similar size. To further protect the circuitry accommodated within the housing, an insulating epoxy resin material is used to fill any voids. The winding cavity is defined to provide space for insulating material and protective encapsulation for safe and reliable operation at the required voltage and temperature in an environment such as a production tubing of a hydrocarbon extraction facility. Generally, multi-turn primary coil extends along elongated cylindrical housing being accommodated in a general parallel manner with respect to planar plate-like area 8 of housing 4. In particular, planar plate-like area 8 provides a protective cover for primary coil to allow mechanically opposite second transceiver 6 to be aligned mostly congruent for the purpose of a transferring of data and/or power signals therebetween as will described later.

Also provided is rotational stop element, and as will be described later, limits the rotational movement between first transceiver against second transceiver during the transfer of signals therebetween. As will be shown in subsequent figures, housing shape of first (and subsequently second transceiver) is chosen to complement the general design of production tubing or annular space is defined outside production tubing and inside casing.

In another example embodiment of the present invention, the pipeline instrumentation and control system of the present invention may be used to control a valve inside the hydrocarbon production pipe. Such a valve may be utilized to release pressure within the drilled bore hole or may be used to seal a flow channel. In any case, such a valve would rely on data communications for operation. In such an example embodiment the valve is positioned a great distance from a communications interface 60 such that the control signal needs to be repeated prior to arriving at a top side control centre 68.

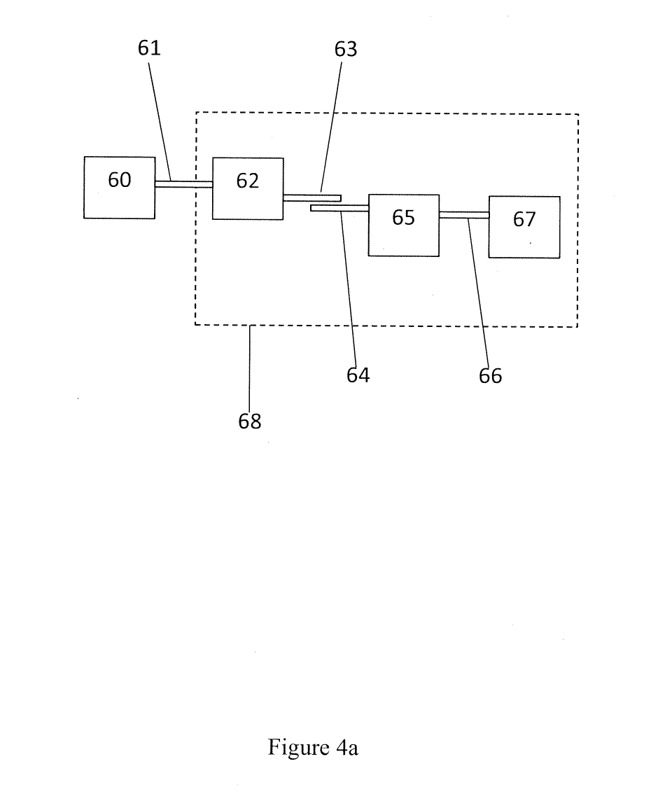

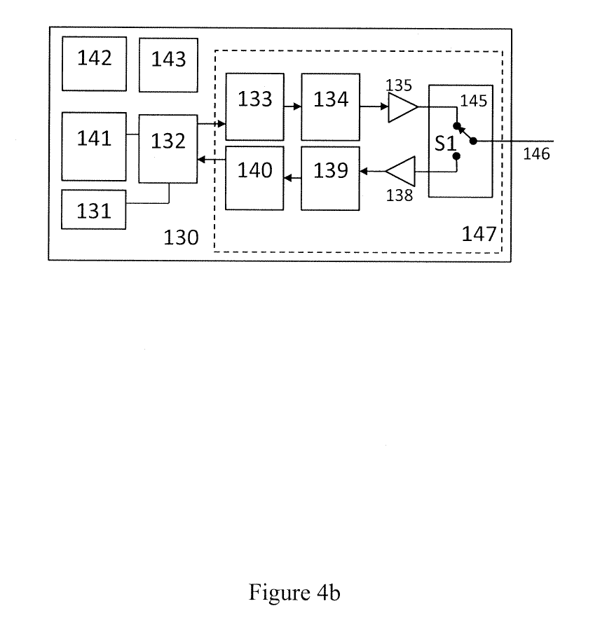

In an example embodiment shown in FIG. 4a, transmission line 61 carries a data signal containing a command signal for sensor and/or data logger and/or electrical device and/or electro-mechanical device such as a valve. As can be seen in the current figure, first conducting cable connected to first transceiver is positioned within hydrocarbon production pipe such that it overlaps second transceiver. Transceiver 65 receives the coupled signal and generates a control signal on transmission line 66 suitable for interfacing to second transceiver 67. Valve interface may be one part of a general valve module that may contain for example a processor, transceiver, data logger and optionally a power supply. Consequently, valve is operationally manipulated by received control signal. Such operational manipulation may be one of opening and/or closing of said valve with such manipulation being dependent on the requirements of the command centre. Optionally and preferably, transmitter part of transceiver forming part of general valve module sends a periodical acknowledgment signal to the command centre such that command centre personnel are aware of the current operational status of the valve. In such a scenario, the transmitter part of the transceiver generates a modulated signal being representative of the acknowledgement signal. As previously discussed, the valve module generates a modulated signal in transmission line 66 that represents the acknowledged signal. This modulated signal is received by transceiver 65 which generates a conditioned signal in radiating cable 64. Radiating cable 63 receives the signal generated in radiating cable 64 and this signal is received by transceiver 62. Transceiver 62 receives the coupled signal and generates a signal on transmission line 66 suitable for transmission to communications interface 60. Equally, the configuration of the signal coupling system of the present invention may be used for transmission of captured data from for example a data logger such that the control system allows captured data in bore well within a production pipe to be transmitted to a control centre. In such a scenario, data from a valve unit, a drilling unit, a senor unit e.g. for monitoring stability of pipe, and/or other device generating data required by a command centre may be stored on a data logger and transmitted periodically or constantly to the command center.

As shown in FIG. 4b, container within a single housing are first and second transceivers 62, 65. In practice, containment of first and second transceivers held within a single housing affords several advantages not least power supply considerations. Clearly, and as depicted in the current figure, both transmitter and receiver circuitry are powered from a single source 142 thus ensuring easier power budget considerations. Circuitry 143 ensures that power supply output is regulated prior to powering subsequent circuitry.

As further shown in the current figure is a processor module 132 which runs specialized software under the command of control center 68. Further, processor module is connected to timing circuit 141 such to provide a timing clock cycle and further interacted to data interface 131. Modulator 133 is connected to line interface 147 and controlled by processor module 132. Modulator modulates incoming signal from line interface 133 with its digital output converted to an output signal by means of converter 134. To correct for signal amplitude variations, analogue signal is amplifies by means of amplifier 135 and then sent to radiating cable 146 as an outgoing signal to sensor and/or data logger and/or electrical device and/or electro-mechanical device within production well tubing by means of transceiver switch 51. Similarly, incoming signal (that is, incoming towards control center 68) from sensor and/or data logger and/or electrical device and/or electromechanical device arranged within production well tubing is routed via switch 51 to receive amplifier. Output of receive amplifier is connected to analogue to digital converter 139 such that digital signal is demodulated at demodulator 140 and processed at module 132. As can be seen in the current figure, modulator 133, digital to analogue converter 134, amplifier 135, receive amplifier 138, analogue to digital converter 139, demodulator 140 are all connected to module 132 for signal processing.

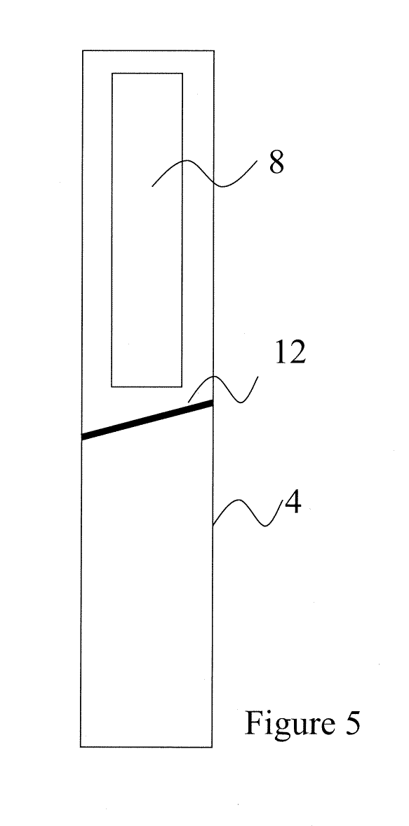

FIG. 5 shows a simplified front view of a first transceiver 4 according to an embodiment of the present invention. Again, and for the purpose of clarity, transceiver is rotated by 180 degrees compared to the illustration of FIG. 2. As depicted in the current illustration, cylindrical shaped transceiver element includes a housing 4 for the containment of interface circuitry and a multi-turn primary coil (not shown). Generally, multi-turn primary coil extends along length of elongated housing and being accommodated in a general parallel manner with respect to planar plate-like area 8 of housing. In particular, planar plate-like area 8 provides a protective cover for primary coil and serves to allow mechanically opposite second transceiver (not shown) to be aligned mostly congruent with the planar plate-like area for the purpose of transferring of data and/or power signals therebetween.

As is further depicted in the current illustration, cylindrical shaped transceiver comprises a rotational stop element 12. Rotational stop element 12 may be provided as an angled protruding flange and preferably arranged at the intersection between cylindrical and semi-cylindrical shape of transceiver housing. Preferably, rotational stop element is arranged on the same plane as the plate-like area 8 of transceiver housing 4. Although not currently depicted, second transceiver housing is provided with a corresponding recess which allows mechanically opposite protruding flange to mate therein when coupling system of the present invention is in use.

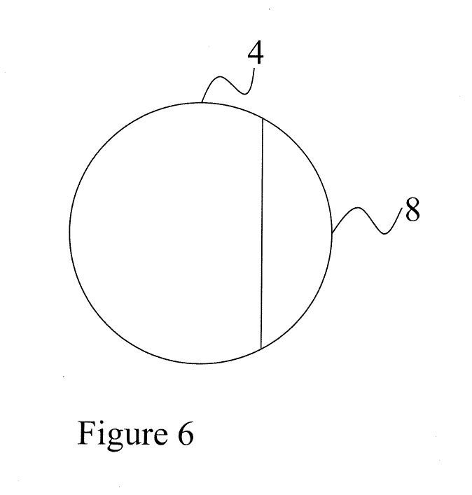

FIG. 6 shows a simplified plan view of a first transceiver (or second transceiver) showing cylindrical shaped housing 10 and plate-like planar area 8 according to an embodiment of the present invention. Housing shape of first 8 (or second transceiver 10) is chosen to complement the general design of production tubing or annular space of production tubing. Annular space is defined as being outside production tubing and inside casing of hydrocarbon extraction well to which signal coupling system of the present invention may be utilized. Intersecting line across transceiver housing depicts the semi-cylindrical cut-away defining a planar plate-like area for accommodating primary coil or secondary coil of transceiver.

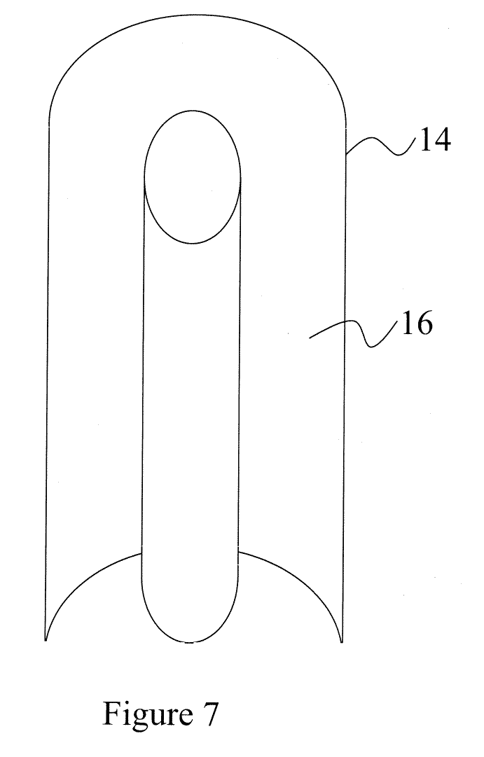

FIG. 7 shows a simplified view of a production tube 14 within a casing and shown in cross section. As illustrated, production tubing 14 is positioned concentric to casing. An annular space 16 is defined outside production tubing 14 and inside casing. As will be shown later, the signal coupling system 2 of the present invention may be deployed within production tubing 14 or within annular space 16.

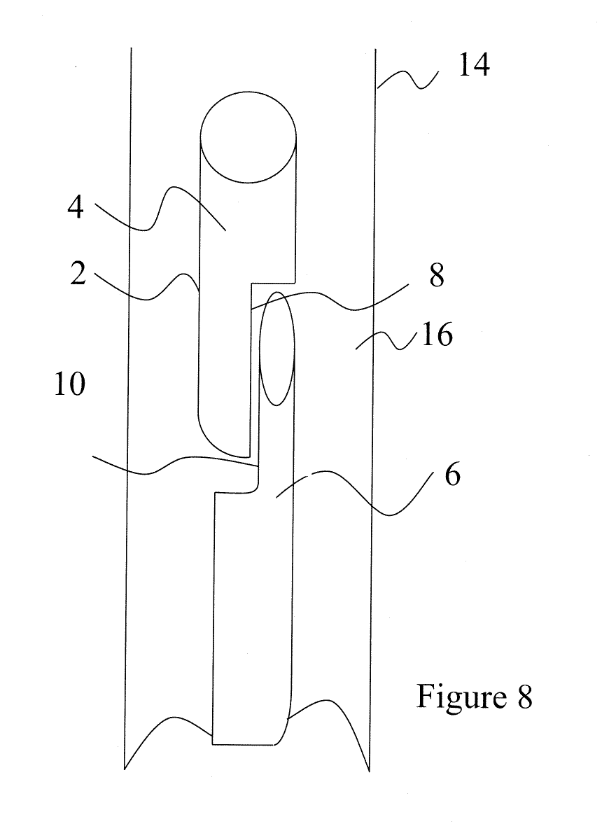

FIG. 8 shows a simplified view of the signal coupling system of the present invention comprising a first transceiver generally aligned in a overlapping parallel formation to a second transceiver and separated by a gap for facilitating the transfer of signals therebetween and arranged in a production tube within a casing of a well production system according to an embodiment of the present invention. As can be seen in the current figure, cylindrical housing for first transceiver is separated by a gap from cylindrical housing of second transceiver. Rotational stop element 12 of first transceiver 4 and by means of protruding flange interlocks with mechanically similar recess of second transceiver for ensuring first and second transceiver 4, 6 forming signal coupling system 2 of the present invention are not disturbed—and thus providing a reliable coupled system—by the flow of extracted hydrocarbon material from the well and furthermore by solid material flowing within the production tubing. In particular, housing of first transceiver houses primary loop being disposed generally parallel to planar plate-like area 8 of first transceiver. Similarly, housing of second transceiver houses secondary loop and disposed generally parallel to planar plate-like area of second transceiver. Typically, gap between first and second plate-like area is between 1 to 2 cm. Preferably, first transceiver and second transceiver 4, 6 are arranged on the longitudinal of production tubing thus maximizing the exposure between first and second plate-like area of first and second transceivers. Planar plate-like areas 8, 10 of first and second transceivers 4, 6 are aligned mostly congruent to each other to maximise the interconnection between first and second planar like-areas 8, 10 thus causing primary loop and secondary loop to overlap. As the primary and secondary loops of first and second transceivers overlap magnetic flux generated by currents in primary loop intersects the secondary loop and facilitates transfer of data signals and/or power signals. Flux guides of the first and second transceivers form a magnetic circuit which couples magnetic flux generated in the primary coil to the secondary coil.

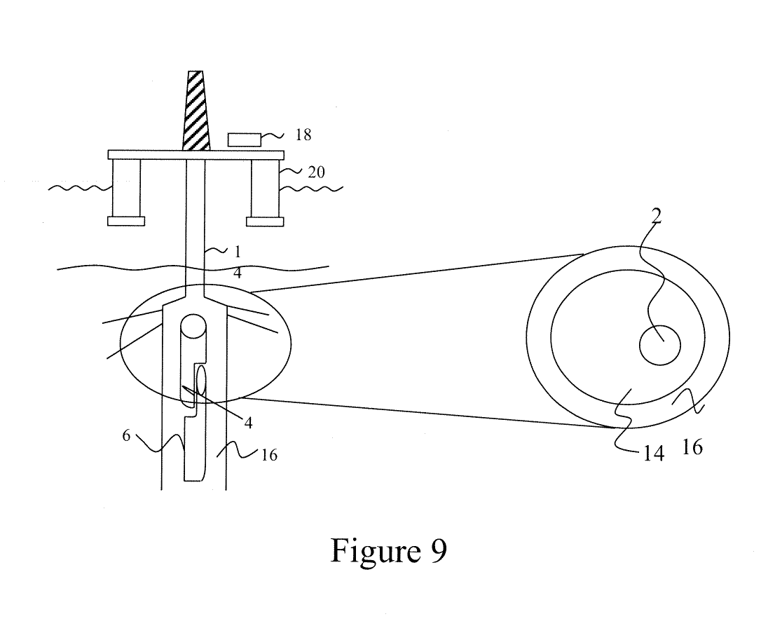

FIG. 9 shows a simplified overview of an example hydrocarbon well production system 20 incorporating the signal coupling system 2 of the present invention. Riser links lower stack at the seabed with topside rig 20. A control station 18 for the hydrocarbon production system is typically located within topside rig or platform and wellhead penetrates into seabed. Downhole sensor and downhole tool are located within the production string remotely from the control station. First transceiver and second transceiver 4, 6 are distributed throughout the production piping 14 and provide the transfer of signals (e.g. data and/or power signals) between sensor deployed within the production tubing 14 and control station 18. The cylindrical shape of the first transceiver and second transceiver 4, 6 are arranged along the longitudinalwithin the production tubing (or annular space) and complement the cylindrical design of production tubing 14 of a hydrocarbon extraction well. The flow of extracted hydrocarbon material from the well is therefore not impeded during extraction thus allowing control signals from a control station to sensors arranged within the production tubing to continue without interruption. Furthermore solid material flowing within the production tubing does not impact the signal coupling system since any material will flow upwards towards the topside rig by-passing the longitudinalaligned signal coupling system. The signal coupling system described in this application could alternatively be applied to a Floating Production, Storage, and Offloading (FPSO) based system or a land based subsurface production system.

### Operational Deployment Method

In an example embodiment, the deployment of the signal coupling system of a hydrocarbon extraction well facility may be according to the following example method:

In a first step, a second conducting cable having a proximal end and a distal end is located. Next, said second conducting cable is inserted into a production well tubing, said proximal end connected to a second transceiver and further wherein said distal end connected to a sensor and/or data logger and/or electrical device and/or electro-mechanical device. Next, second conducting cable is positioned at distal end of production well tubing such that sensor and/or data logger and/or electrical device and/or electro-mechanical device is positioned distally from second transceiver. Next, first conducting cable is located, said cable having a proximal end and a distal end. Next, first conducting cable is inserted into a production well tubing, said proximal end connected to a control command centre and further wherein said distal end connected to a first transceiver. Finally, distal end of first conducting cable comprising first transceiver is manipulated within production cable well tubing over proximal end of second conducting cable comprising second transceiver such that bi-directional signal transfer occurs between command centre and sensor and/or data logger and/or electrical device and/or electro-mechanical device.

Whilst the present invention may have particular applicability to hydrocarbon extraction wells, it is should be noted that the present invention is also applicable to other types of industries where the transfer of signals between a control station and sensors and/or mechanical actuators in a confined space such as piping is required.

Various embodiments of the invention have been described above. The descriptions are intended to be illustrative, not limitative. Thus, it will be apparent to one skilled in the art that certain modifications may be made to the invention as described without departing from the scope of the claims set out below.

1. A signal coupling system for the transfer of data and/or power signals, the system comprising:
a first transceiver having a primary loop arranged at a first end thereof with a first plane enclosed by said primary loop being arranged substantially orthogonal to said first end;
a second transceiver having a secondary loop arranged at a second end thereof with a second plane enclosed by said secondary loop being arranged substantially orthogonal to said second end;
said transceivers arranged oppositely with said first and said second ends overlapping such that said first plane and said second plane are in substantially parallel alignment to facilitate electromagnetic coupling therebetween.

2. A signal coupling system according to claim 1 wherein said primary and said secondary loop are directly opposed to maximise the electromagnetic coupling.

3. A signal coupling system according to claim 1 wherein said first and second ends are semi-cylindrical housings in which are located said primary and said secondary loops respectively, each housing having a first and second face respectively and said first and second faces being in substantially parallel alignment with said primary and said secondary loops respectively.

4. A signal coupling system according to claim 2 wherein said first and second faces are arranged oppositely to provide a substantially cylindrical coupling member.

5. A signal coupling system according to claim 4 wherein said first and second transceivers are substantially cylindrical members such that the system has a substantially cylindrical body.

6. A signal coupling system according to claim 5 wherein a ledge formed at a junction of said cylindrical member and said semi-cylindrical housing provides a guide surface.

7. A signal coupling system according to claim 6 wherein a front surface at a distal end of said cylindrical housing is shaped to mate with said guide surface.

8. A signal coupling system according to claim 7 wherein said front surface and said guide surface are arranged at an angle with respect to said first face.

9. A method of data and/or power transfer, comprising the steps:
(a) providing a signal coupling system having:
a first transceiver having a primary loop arranged at a first end thereof with a first plane enclosed by said primary loop being arranged substantially orthogonal to said first end;
a second transceiver having a secondary loop arranged at a second end thereof with a second plane enclosed by said secondary loop being arranged substantially orthogonal to said second end;
(b) connecting said first transceiver to a device;
(c) bringing said second transceiver to said first transceiver;
(d) overlapping said ends of said transceivers such that said first plane and said second plane are in substantially parallel alignment to facilitate electromagnetic coupling therebetween; and
(e) transmitting data and/or power between said transceivers by electromagnetic induction.

10. A method according to claim 9 wherein the method includes the step of rotationally aligning mating surfaces on said transceivers.
